(19) United States
(12) Patent Application Publication
(10) Pub. No.: US 2026/0269972 A1
(43) Pub. Date: Sep. 10, 2026

(54) SYSTEMS AND METHODS FOR SIGNAL JAMMING

(71) Applicant: L3Harris Global Communications, Inc., Melbourne, FL (US)

(72) Inventors: Dan Harris, Rochester, NY (US); James Buduson, North Chili, NY (US); Marc Schwartz, Macedon, NY (US)

(21) Appl. No.: 18/945,674

(22) Filed: Nov. 13, 2024

(51) Int. Cl. H04K 3/00

(52) U.S. Cl. CPC H04K 3/45; H04K 3/28

(57) ABSTRACT

Systems and methods for operating a communication network (CN). The methods comprise: receiving a signal by a first node in CN; analyzing the signal to detect characteristic(s) thereof; obtaining, based on the detected characteristic(s), a timeslot or channel schedule or definitions comprising at least one first timeslot or channel that is to be used for network scanning and at least one second timeslot or channel that is to be used for signal jamming; and controlling operations of one or more nodes to emit a noise or jamming signal during the first timeslot(s) or channel(s), scan for signals transmitted by an uncooperative communication device during the second timeslot(s) or channel(s), and transmit communication signals during respective third timeslot(s) or channel(s).

### BACKGROUND

Remotely controlled unmanned vehicles include airborne, land and water vehicles. Unmanned airborne vehicles (UAVs) are commonly referred to as drones. An operator uses radio frequency (RF) signals to remotely control an unmanned vehicle. In some cases, the unmanned vehicle may have reduced signal reception due to its operating environment.

Reduced signal reception may be caused by an RF interference source within the operating environment of the unmanned vehicle. The RF interference source may be intentional or unintentional. Intentional RF interference may be from an RF jammer, for example. In this case, the RF jammer operates within the same frequency band as an RF receiver being carried by the unmanned vehicle. Unintentional RF interference may be from RF transmitters operating in close proximity to the unmanned vehicle.

### SUMMARY

This document concerns implementing systems and methods for operating a communication network. The methods comprise: receiving a signal by a first node of a plurality of nodes in the communication network; analyzing, by the first node, the signal to detect one or more characteristics thereof; obtaining, based on the detected one or more characteristics of the received signal, a timeslot schedule comprising at least one first timeslot of a plurality of timeslots in an epoch duration that is to be used for network scanning and at least one second timeslot of the plurality of timeslots that is to be used for signal jamming; and controlling operations of a node or among a plurality of nodes to emit a noise or jamming signal during the at least one first timeslot, scan for signals transmitted by an uncooperative communication device during the at least one second timeslot, and transmit communication signals during respective third timeslot(s) of the plurality of timeslots.

This document also concerns a communication device. The communication device comprises: a transceiver and a processor. The transceiver is configured to receive a signal. The processor is configured to: analyze the signal to detect one or more characteristics thereof; obtain, based on the detected one or more characteristics of the received signal, a timeslot schedule comprising at least one first timeslot of a plurality of timeslots in an epoch duration that is to be used for network scanning and at least one second timeslot of the plurality of timeslots that is to be used for signal jamming; and emit a noise or jamming signal during the at least one first timeslot, scan for signals transmitted by an uncooperative communication device during the at least one second timeslot, and transmit a communication signal during a respective third timeslot of the plurality of timeslots. The communication device may comprise a ground-based radio or be disposed on an aerial vehicle.

The present document also concerns implementing systems and methods for operating a communication network. The methods comprise: receiving a signal by a first node of a plurality of nodes in the communication network; analyzing, by the first node, the signal to detect one or more characteristics thereof; obtaining, based on the detected one or more characteristics of the received signal, a channel schedule comprising at least one first channel of a plurality of channels in a frequency band that is to be used for network scanning and at least one second channel of the plurality of channels that is to be used for signal jamming; and controlling a node to emit a noise or jamming signal during the at least one first channel, scan for signals transmitted by an uncooperative communication device during the at least one second channel, and transmit communication signals during respective at least one third channel of the plurality of channels.

### BRIEF DESCRIPTION OF THE DRAWINGS

This disclosure is facilitated by reference to the following drawing figures, in which like numerals represent like items throughout the figures.

FIG. 1 provides an illustration of a system implementing the present solution.

FIG. 2 provides a graph plotting signal power measurements verse frequency.

FIG. 3 provides an illustration of a communication device.

FIGS. 4A-4B (collectively referred to as “FIG. 4A”) provide illustrations of an aerial vehicle.

FIGS. 5-6 each provides an illustration of an epoch duration.

FIG. 7 provides a table showing slot type assignments to timeslots of an epoch duration.

FIG. 8 shows a timing-based waveform relative to the associated timeslots.

FIGS. 9A-9B (collectively referred to as “FIG. 9”) provides a flow diagram of an illustrative method for operating a communication network.

FIGS. 10-11 each provide a flow diagram of another illustrative method for operating a communication network.

### DETAILED DESCRIPTION

UAVs may be configured to prosecute missions in low-to-medium altitude airspace in an RF contested environment. The low-to-medium altitude airspace may be up to, for example, 100 meters. Telecommunication payloads often utilize time division multiple access (TDMA) waveforms to conduct their mission. The TDMA waveforms may be leveraged to pass data or disrupt interfering communication links.

An electronic support-measure (ESM) may be integrated with a communications link to provide the end user with (i) relevant situation awareness in the contested environment and (ii) a layer of protection against small unmanned aerial system (sUAS) threats. The end user may benefit from a waveform leveraging ESM data through the time slots of a waveform for additional situational awareness. ESM comprises anything that gives situational awareness in an environment. ESM capabilities can be added to a lightweight smart antenna that would compliment waveforms to increase resilience of the communication system. An integrated ESM may also provide a platform with an ability to jam interfering communication adjacent to relaying ground communication.

Jammers and configurable software defined radios (SDRs) exist which can be used for ESM/electronic counter measure (ECM) or communication equipment, and dedicated communication link SDRs. There are no single input single output (SISO) SDRs used as ECM, ESM and communication equipment.

The present solution provides a way to combine an electronic warfare (EW) network and a mobile ad hoc network (MANET) on UAVs or a fleet of communication devices carried by end users. The EW network features that are incorporated with the ad hoc network can include, but are not limited to, electronic attack features and network scanning features. Scanning operations and effect (or jamming) operations are interleaved in timeslots of the ad hoc network. The scanning and effect operations are coordinated amongst multiple communication devices within the ad hoc network (e.g., UAVs and/or radios). The present solution can achieve, for example, at least sixty percent duty cycle in a narrowband network. Users lose bandwidth due to loss of timeslots. The higher the duty cycle the more effective at jamming signals from uncooperative communication devices, but the user must sacrifice data throughput. The present solution can be implemented in a narrowband ad hoc network and/or a wideband ad hoc network. The narrowband ad hoc network may, for example, operate over a 75 kHz frequency range. The wideband ad hoc network may, for example, operate over a 10-40 MHz frequency range.

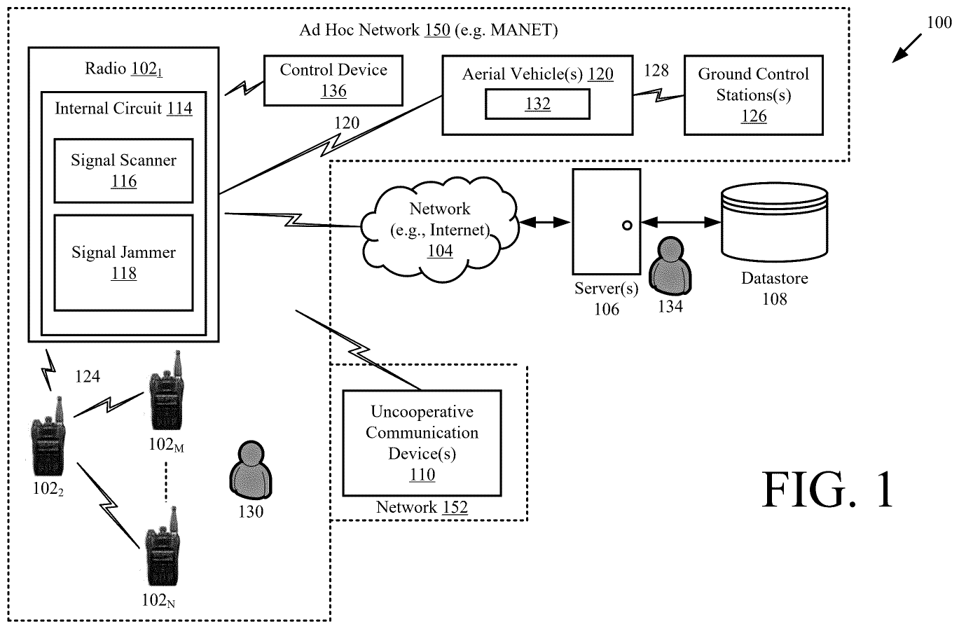

FIG. 1 provides an illustration of a system 100 comprising an ad hoc network 150 and another network 152 which is uncooperative with the ad hoc network 150. Network 152 comprises uncooperative communication device(s) 110. Networks 150, 152 are unfriendly with each other, i.e., they do not intentionally share communication channels.

System 100 is configured, for example, to manage operations of field personnel member(s) 130 of an organization. The field personnel members may be assigned to radio configuration. Each field personnel member is assigned and provided a radio 102₁, 102₂, 102_{M}, . . . , 102_{N} (collectively referred to as “102”). Each of M and N is any integer equal to or greater than one. Each radio 102₁, 102₂,. 102_{N} is configured to provide communication with other radios in its talk group via wireless communications.

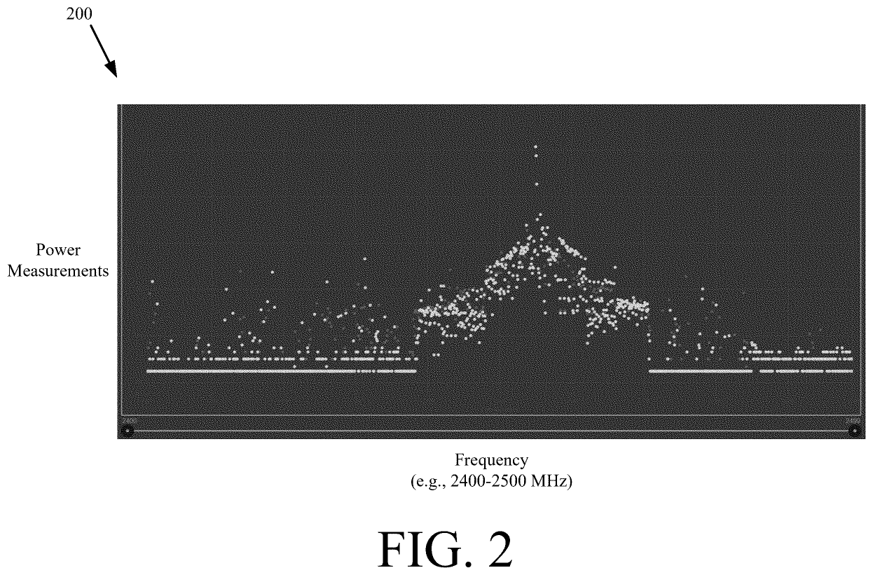

Each radio 102₁, 102₂, . . . , 102_{N} implements the present solution, and therefore is configured to perform scanning operations and effect (or jamming) operations in select timeslots or channels of the ad hoc network. The effect operations are performed to jam signals from the uncooperative communication device(s) 110. In this regard, each radio 102₁, 102₂, . . . , 102_{N} comprises a signal scanner 116 and a signal jammer 118. These components 116 and 118 may be implemented in hardware, software and/or a combination thereof. The scanning operations can include, but are not limited to, taking signal power measurements over a given frequency range, and/or determine I/Q levels (e.g., amplitude of an in-phase signal and amplitude of quadrature signal). For example, one or more of the radios may take power measurements in 75 KHz chunks while maintaining the ad hoc network. The present solution is not limited to the particulars of this example. A graph 200 is provided in FIG. 2 plotting power measurements verse signal frequency. At certain frequencies, the device senses a relatively large amount of power. Any known or to be known technique for taking signal power measurements can be used here. One such known technique that can be used comprises a sweeping spectrum-analyzer.

Ad hoc network 150 also comprises a control device 136 configured to receive scan data (e.g., power measurements) from radios 102₁, 102₂, . . . , 102_{N}, and process the received scan data to determine a location of the uncooperative communication device(s) 110. Any known or to be known technique can be used here to determine the location of a communication device. One such technique is described in U.S. Pat. No. 8,792,464 to Voglewede et al. (“the 464 Patent”). The location determined in accordance with this technique comprises a geolocation of the uncooperative communication device. The determined geolocation may be used to steer an antenna beam for signal jamming purposes.

Aerial vehicle(s) 120 may also implement the present solution in the same or similar manner as radios 102₁, 102₂, . . . , 102_{N}. The aerial vehicle(s) 120 may or may not have onboard human pilots, crew members and/or passengers, or a form of autonomous operation. Each aerial vehicle 120 can include, but is not limited to, an autonomous aerial vehicle, a remotely-piloted aerial vehicle, a UAV, sUAS, a drone, and/or a manned aerial vehicle. The aerial vehicle(s) 120 may be remotely controlled using ground control station(s).

In the remotely-piloted scenarios, an operator 108 (e.g., a Remote Pilot In Command (RPIC)) can remotely control flight operations of the aerial vehicle by using ground control station 126 that is communicatively coupled to an internal circuit 132 of an aerial vehicle 120 via command and control links 128. The internal circuit 132 includes the signal scanner, signal jammer, and/or avionics payload. The avionics payload comprises avionic electronics, i.e., hardware and/or software facilitating positioning, navigation, timing and other functionalities of the aerial vehicle. The aerial vehicle can have any classification (e.g., a Group 1-5 classification, and/or size classification (e.g., very small, small, medium, and/or large).

During flight, the aerial vehicle(s) 120 can act as an airborne relay to wirelessly connect to radios 102₁, 102₂, . . . , 102_{N} located on the ground at locations in which wireless communications therefrom are masked or screened by the line-of-sight (LoS) obstructions (e.g., distance, terrain (e.g., foliage and mountains) and human made objects (e.g., buildings)). The aerial vehicle(s) 120 may also provide situation awareness data to the radios 102₁, 102₂, . . . , 102_{N}, and/or facilitate network scanning and electronic attack operations of system 100.

In this regard, a communications relay is provided with the aerial vehicle. The communications relay may communicate over a secure communications link 120 (e.g., a Small Secure Data Link (SSDL)), use various frequency bands (e.g., Ultra High Frequency (UHF) and Very Hight Frequency (VHF) bands), support a variety of frequencies and waveforms, and extend the range between users 130 for voice and data communications (e.g., text messages and/or imagery data) beyond the LoS range of the radios 102₁, 102₂, . . . , 102_{N}.

Voice and data communications may be provided to other remote devices such as server(s) 106 via network 104. Network 104 can include, but is not limited to, a radio network, a cellular network, and/or the Internet. The remote devices can process and/or output the voice and data communications to users 134 thereof. The voice communications, data communications and/or analytics relating thereto can be stored in a datastore 108.

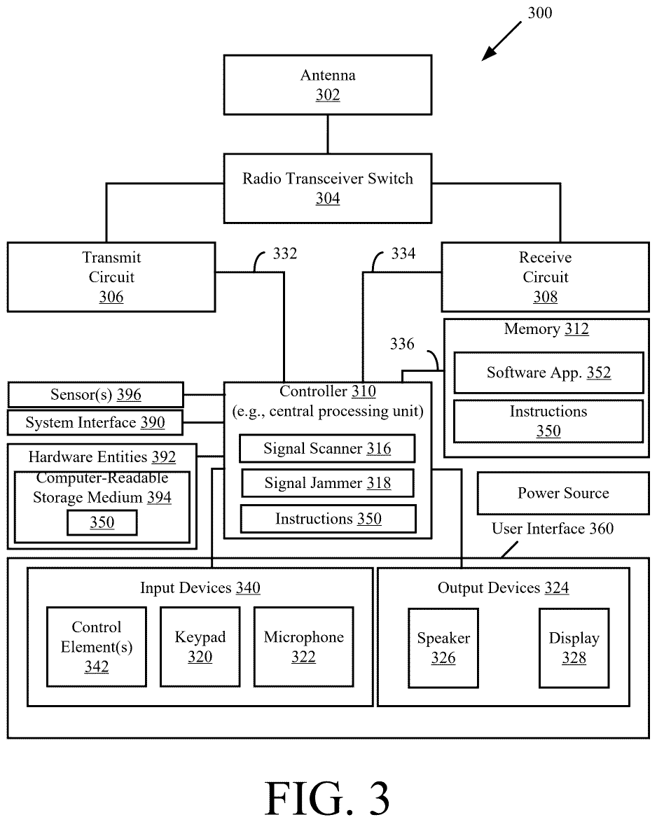

FIG. 3 provides an illustration of an architecture for a communication device 300. Radios 102₁, 102₂, . . . , 102_{N}, circuit 132 of aerial vehicles(s) 120, and/or control device 136 of FIG. 1 may be the same as or similar to communication device 300. As such, the discussion of communication device 300 is sufficient for understanding components 102₁, 102₂, . . . , 102_{N}, 132, 120 and/or 136 of FIG. 1. Communication device 300 can include more or less components than that shown in FIG. 3 in accordance with a given application. However, the components shown are sufficient to disclose an illustrative hardware architecture implementing the present solution.

Communication device 300 comprises an antenna 302 for receiving and transmitting radio frequency (RF) signals. A transceiver switch 304 selectively couples the antenna 302 to a transmit circuit 306 and a receive circuit 308 in a manner familiar to those skilled in the art. Transmit and receive circuits are well known in the art. Still, it should be understood that the transmit circuit 306 is configured to (i) cause information to be transmitted to an external device and/or a network via RF signals and (ii) process RF signals received from the external device and/or network to extract information therefrom. The transmit and receive circuits 306, 308 are coupled to a controller 310 via respective electrical connections 332, 334. In a transmit mode, the controller 310 also provides information to the transmit circuit 306 for encoding and modulating information into RF signals. The transmit circuit 306 communicates the RF signals to the antenna 302 for transmission to an external device. In a receive mode, the receive circuit 308 provides decoded RF signal information to the controller 310. The controller 310 uses the decoded RF signal information in accordance with the function(s) of the communication device 300.

The controller 310 stores the decoded RF signal information in a memory 312 of the communication device 300. Accordingly, the memory 312 is connected to and accessible by the controller 310 through an electrical connection 336. The memory 312 may be a volatile memory and/or a non-volatile memory. For example, the memory 312 can include, but is not limited to, a random access memory (RAM), a dynamic random access memory (DRAM), a static random access memory (SRAM), a read-only memory (ROM), and/or flash memory.

One or more sets of instructions 350 are stored in the memory 312. The instructions 350 can also reside, completely or at least partially, within the controller 310 during execution thereof by the communication device 300. In this regard, the memory 312 and the controller 310 can constitute machine-readable media. The term “machine-readable media”, as used here, refers to a single medium or multiple media that store the one or more sets of instructions 350. The term “ machine-readable media”, as used here, also refers to any medium that is capable of storing, encoding or carrying the set of instructions 350 for execution by the communication device 300 and that cause the communication device 300 to perform one or more of the methodologies of the present disclosure.

The controller 310 is also connected to a user interface 360. The user interface 360 comprises input devices 340, output devices 324, and software routines (not shown in FIG. 3) configured to allow a user to interact with and control software applications 352 installed on the communication device 300. Such input and output devices respectively include, but are not limited to, a display 328, a speaker 326, a keypad 320, a directional pad (not shown in FIG. 3), a directional knob (not shown in FIG. 3), and a microphone 322. The display 328 may be designed to accept touch screen inputs. The input devices 340 also comprise control elements 342. The control elements 342 include, but are not limited to, an on/off switch or button, and/or volume control buttons.

Communication device 300 may also comprise sensors 396. Sensor(s) 396 can include, but is(are) not limited to, environmental sensor(s) for detecting condition(s) of a surrounding environment and/or other sensor(s). The environmental sensor(s) can include, for example, humidity sensor(s), light detection sensor(s), temperature sensor(s), and/or terrain detection sensor(s). The other sensor(s) can include, for example, accelerometer(s), global positioning system (GPS) sensor(s), and/or proximity sensor(s). These sensor(s) 396 can be used to facilitate in-field re-configuration of radios. The manner in which these sensor(s) 396 are used will become evident as the discussion progresses.

In some scenarios, software 316, 318 is executed by the controller 310 to facilitate implementation of the present solution. The software includes signal scanner software 316 and signal jammer software 318. The signal scanner 316 is generally configured to cause the communication device 300 to perform the following operations: identifying timeslots or channels of a communication network that may be used for network scanning and/or signal jamming; assigning a scan slot or channel type or an effect slot or channel type to one or more of the identified timeslots or channels; detecting characteristics (e.g., amplitude, frequency, pulse times, pulse width, modulation type, signal signature, data link type, duty cycle, etc.) of signals received during timeslots or channels assigned a scan slot or channel type; determining parameters (e.g., frequency setting, modulation setting, communication mode setting, etc.) of uncooperative communication device(s); receiving detected signal characteristics and determined uncooperative communication device parameters from external devices; aggregating the signal characteristics to form aggregated dataset(s); transmitting the aggregated dataset(s) to external device(s); and/or determining location(s) of uncooperative communication device(s) based on the detected signal characteristics and/or determined uncooperative communication device parameters.

Signal jammer 318 is generally configured to cause the communication device 300 to perform the following operations: identifying timeslots or channels of a communication network that may be used for network scanning and/or signal jamming; assigning a scan slot or channel type or an effect slot or channel type to one or more of the identified timeslots or channels; selecting a frequency for a jamming signal based on the signal characteristics and/or determined uncooperative communication device parameters; and scheduling transmission of the jamming signal at the selected frequency during timeslots or channels assigned an effect slot or channel type.

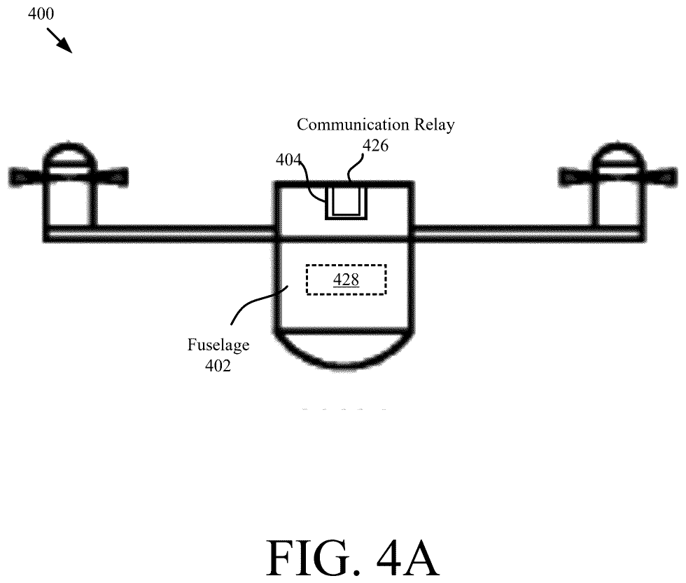

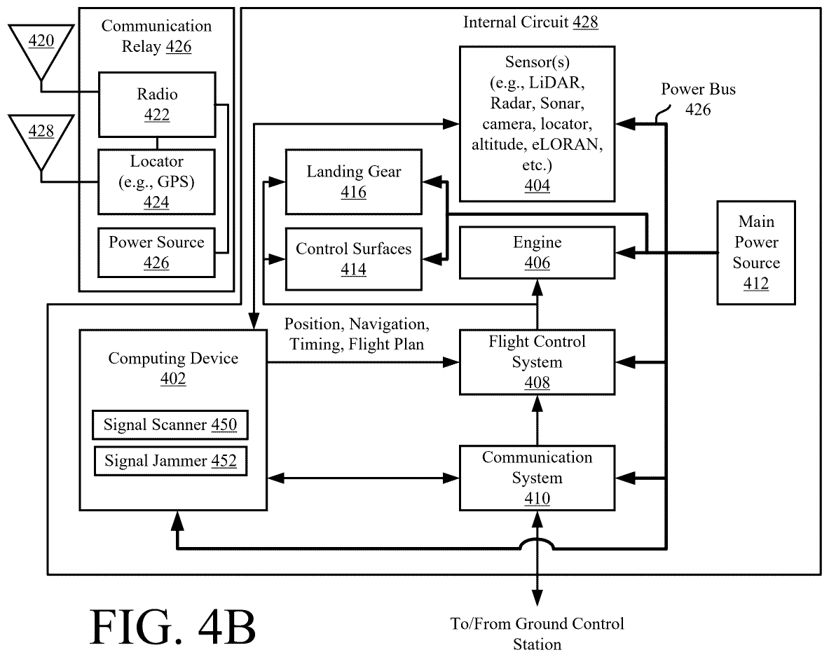

FIG. 4 provides an illustrative architecture for an aerial vehicle 400. Aerial vehicles(s) 120 of FIG. 1 may be the same as or similar to aerial vehicle 400. Thus, the discussion of aerial vehicle 400 is sufficient for understanding aerial vehicle(s) 120.

The internal circuit 428 is disposed inside the fuselage 402 of the aerial vehicle, and the communication relay 426 is disposed in an existing compartment 404 formed in the fuselage 402 of the aerial vehicle. The compartment 404 is accessible from the outside of the aircraft (e.g., via a door or removable panel).

Internal circuit 428 comprises a computing device 402, sensor(s) 404, an engine 406, a flight control system 408, a communication system 410, a power source 412, a control surfaces 414, and landing gear 416. Internal circuit 428 can include more or less components than those shown and listed. The propulsion system can include, but is not limited to, elevators, flaps, ailerons and/or rudders.

Computing device 402 comprises processor(s) that execute(s) instructions to perform at least the following operations: receiving and processing position, navigation and timing (PNT) data from the sensor(s) 404; and/or facilitating flight operations by providing the PNT data and/or a flight plan to the flight control system 408 and/or the ground control station via communication system 410. The PNT data ensures that the operator and/or the aerial vehicle knows the aerial vehicle's current position at any given time. The flight plan ensures that the aerial vehicle knows its destination relative to its current position which is useful especially in autonomous aircraft applications.

Sensor(s) 404 can include, but are not limited to, a LiDAR system, a radar system, a sonar system, a camera, a locator (e.g., GPS device), an altitude sensor, and/or an eLORAN device. It should be noted that the locator of internal circuit 428 does provide information that facilitate the operators in determining the location of the aerial vehicle.

The communication system 410 provides a means to transmit PNT data and/or other information to the ground control station, and to receive command and control information from the ground control station. The command and control information is passed from the communication system 410 to the computing device 402 and/or the flight control system 408. The flight control system 408 controls operations of the engine 406, propulsion system 414, and/or landing gear 416 in accordance with the commands and control information received from the ground control station.

The components 402-410, 414, 416 are supplied power from a main power source 412. The main power source 412 can include, but is not limited to, a battery and/or an energy harvesting circuit (e.g., comprising a super capacitor to store harvested energy from heat, wind, light, RF signals, etc.). The power is supplied from the main power source 412 to components 402-410 via a power bus 426.

The communication relay 426 is independent from the internal circuit 428 and consists of a standalone payload for the aerial vehicle. The communication relay 426 may be supplied power from the main power source 412 of the aerial vehicle via power bus 426. Additionally or alternatively, the communication relay 426 is provided with another power source 426. Power source 426 can include, but is not limited to, a battery (e.g., a Lithium Polymer (LiPo) battery) and/or an energy harvesting circuit. Such a power source arrangement ensures that the components 422, 424 of the communication relay 426 continue to operate when the internal circuit 428 is no longer being supplied power from the main power source 412. The components include a radio 422 and a locator 424. The locator 424 can include, but is not limited to, a GPS device. Notably, the locator 424 provides a means to allow all users in a communication relay link to know the location of the aerial vehicle at any given time, and therefore provides these users with situational awareness (SA) information. An antenna 428 is provided for the locator 424.

In some scenarios, software 450, 452 is executed by the computing device 402 to facilitate implementation of the present solution. The software includes signal scanner software 450 and signal jammer software 452. The signal scanner 450 may the same as or similar to signal scanner 316 of FIG. 3. Similarly, signal jammer 452 may be the same as or similar to signal jammer 318 of FIG. 3. The discussion of the signal scanner and jammer 318, 316 is sufficient for understanding signal scanner and jammer 450, 452.

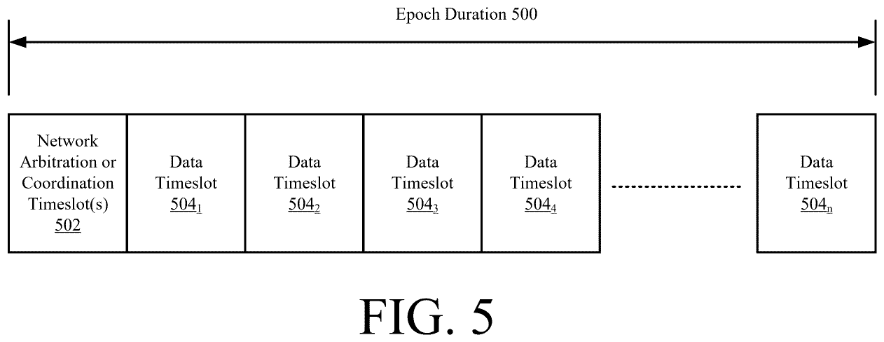

FIG. 5 provides an illustration of an epoch duration 500 for the ad hoc network 150 of FIG. 1. Ad hoc network 150 employs a timing-based waveform. There are many different network protocols for timing-based waveforms. A brief description of a TDMA modulation technique will now be described. In accordance with the TDMA modulation technique, multiple users share a single radio frequency by dividing it into timeslots.

Typical ad-hoc TDMA systems include network arbitration timeslots 502 followed by data timeslots 504₁, . . . , 504ₙ (collectively referred to as “data timeslots 504”). Within each data timeslot, a predetermined radio is allowed to transmit. The pattern of arbitration and data timeslots is repeated over and over. This fundamental duration is called the epoch duration 500.

Each radio in the network arbitrates an assigned timeslot to transmit. During the other allocated user (or radio transmit) timeslots, each radio will listen to the transmission for data that is addressed to them. The assignment of a data timeslot is controlled by the MAC layer for the communications waveform. Typically, a single radio in the network acts as the arbitrator master of the timeslots. This radio may include, but is not limited to, control device 136 of FIG. 1.

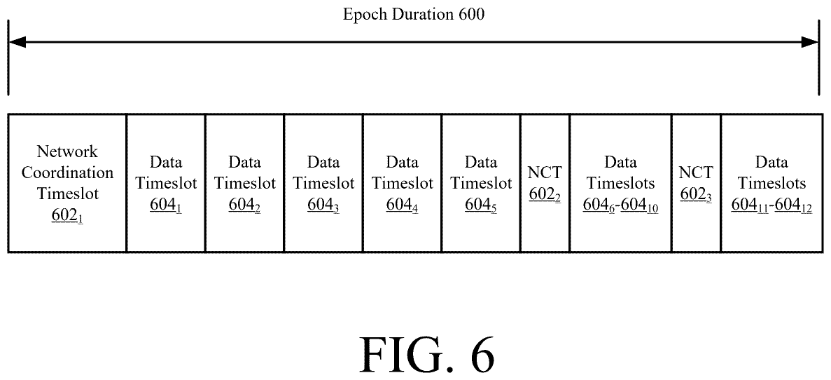

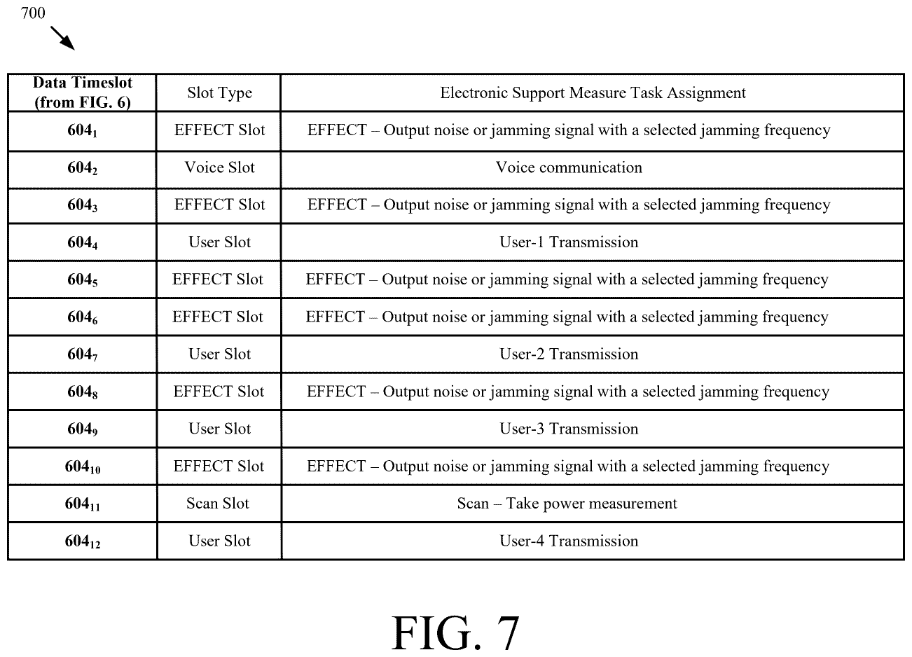

FIG. 6 provides an illustration of another TDMA modulation technique in which multiple users share a single radio frequency by dividing it into timeslots. In this case, network coordination timeslots 602₁, 602₂ and 602₃ are distributed amongst twelve data timeslots 604₁-604₁₂. Specifically, network coordination timeslot 602₁ is the first timeslot in the epoch duration 600. A first network coordination timeslot 602₁ is followed by five data timeslots 604₁-604₅. A second network coordination timeslot 602₂ is located after data timeslot 604₅ and is followed by the next five data timeslots 604₆-604₁₀. A third network coordination timeslot 602₃ is located after data timeslot 604₁₀ and is followed by the last two data timeslots 604₁₁-604₁₂.

Select ones of the data timeslots 604₁-604₁₂ may be used for voice, specific user transmission, network scanning, and/or signal jamming. The determination as to how each data timeslot is to be used may be pre-configured, pre-defined, user configured, and/or automatically performed by a communication device without any user input. In the pre-defined scenario, a plurality of timeslot schedules are pre-defined and stored in local memory or remote memory accessible to the network node(s). Table 700 is provided in FIG. 7 which shows an illustrative timeslot schedule with exemplary slot type assignments for the data timeslots 604₁-604₁₂. The timeslot schedule of table 700 may be a pre-defined, fixed and/or know timeslot schedule, or may alternatively be an automatically and/or dynamically determined timeslot schedule. Table 700 also shows the action that is taken in each data timeslot in accordance with their assigned slot types. The slot types can include, but are not limited to, effect slot, voice slot, user (or radio transmit) slot, and scan slot. The slot type assignments can be pre-defined, user-configured, automatedly made, dynamically made at a given time or at periodic intervals, and/or made automatedly on-the-fly based on the communication needs of the network.

The dynamic and/or on-the-fly slot type assignments can be made based on signal power measurements, detected signal characteristics, and/or determined geolocations of uncooperative communication device(s). This may involve: selecting a total number of data timeslots in a data epoch that should be assigned an effect slot type based on signal power measurements, detected signal characteristics (e.g., amplitude, frequency, pulse times, pulse width, modulation type, data link type, duty cycle, etc.), and/or determined geolocations of uncooperative communication device(s); selecting a minimum, maximum or actual number of data timeslots that should reside between two adjacent effect slots based on the same or different information; selecting a total number of data timeslots in a data epoch that should be assigned a scan slot type based on signal power measurements, detected signal characteristics, and/or determined geolocations of uncooperative communication device(s); and/or selecting a minimum, maximum or actual number of data timeslots that should reside between two adjacent scan slots based on the same or different information.

For example, data timeslots 604₁, 604₃, 604₅, 604₆, 604₈, 604₁₀ are assigned the effect slot type. As such, RF energy is output from the communication devices on a selected jamming frequency. The whole network may be dedicated to outputting RF energy on the jamming frequency during the effect slots. The effect or jamming operations of multiple communication devices may be coordinated. The jamming frequency may be selected, for example, to be the frequency associated with a highest power measurement. Additionally or alternatively, one of a plurality of pre-defined jamming techniques may be selected and used by the communication devices of the network to jam signals from uncooperative communication devices during the effect slots. The jamming technique may be selected based on a detected modulation type, a detected signal signature, and/or a detected communication mode for uncooperative communication device(s). The jamming techniques may be different in relation to timing, signal strength, signal type, and/or signal frequency.

Data timeslot 604₂ is assigned the voice slot type such that a voice communication will be performed therein. Data timeslots 604₄, 604₇, 604₉, 604₁₂ are assigned the user (or radio transmit) slot type. Accordingly, a communication device (e.g., radio 102₁ of FIG. 1) of a first user is able to transmit during data timeslot 604₄, while all other communication devices in the network listen during this data timeslot. A communication device (e.g., radio 102₂ of FIG. 1) of a second user is able to transmit during data timeslot 604₇, while all other communication devices in the network listen during this data timeslot. A communication device (e.g., radio 102_{M} of FIG. 1) of a second user is able to transmit during data timeslot 604₉, while all other communication devices in the network listen during this data timeslot. A communication device (e.g., radio 102_{N} of FIG. 1) of a second user is able to transmit during data timeslot 604₁₂, while all other communication devices in the network listen during this data timeslot.

The signal frequency used during network coordination slots 602₁-602₃, voice slot 604₂, and/or user (or radio transmit) slots 604₄, 604₇, 604₉, 604₁₂ may be different than or the same as the signal frequency used during effect slots 604₁, 604₃, 604₅, 604₆, 604₈, 604₁₀. In the later case, the system may coordinate a change of communication frequency for timeslots 602₁-602₃, 604₂, 604₄, 604₇, 604₉, and/or 604₁₂ to the selected jamming frequency provided that intended network communications are not jammed or otherwise impacted. A decision to use the selected jamming frequence in timeslots 602₁-602₃, 604₂, 604₄, 604₇, 604₉, and/or 604₁₂ may be made based on signal power levels for signals emitted by network nodes, signal power levels of signals emitted from uncooperative communication device(s), and/or geolocations of the uncooperative communication device(s). In some cases, the effect or jamming signals are transmitted using the jamming frequency during the effect slots while the jamming frequency is also being used in other types of timeslots. In other scenarios, the effect or jamming signals are not transmitted during the effect slots while the jamming frequency is being used in other types of timeslots. This feature of the present solution allows the network to be hidden from adversaries.

Each data timeslot 604₄, 604₇, 604₉, 604₁₂ may be at least partially used to communicated scan data (e.g., signal power measurements, detected signal characteristics, and/or determined signal parameters) a respective communication device to one or more other communication devices. This feature of the present solution allows for scan data to be relayed back to a central control device of the network and/or relayed to multiple communication devices that are configured to provide distributed control of network communications.

Data timeslot 604₁₁ is assigned a scan slot type so that one or more communication devices in the network perform scanning operations. The scanning operations can include, but are not limited to, taking signal power measurements over a given frequency range, and/or determine I and Q signal levels (e.g., amplitude, phase and/or frequency modulation type). This given frequency range may be referred to as a scan hopset range. The scan hopset range may be user configurable or pre-defined. Multiple communication devices of the network may be dedicated to scanning during the scan slots. The scanning operations of multiple communication devices may be coordinated. For example, first communication devices may be configured to scan a first portion of a frequency band, while second communication devices are configured to can a second portion of the frequency band. Alternatively, the communication devices may be configured to each scan a respective portion of the frequency band. The more communication devices performing scanning operations results in faster scanning and/or the collection of more signal information during each scan slot. Scanning operations may also be performed between guard times of timeslots.

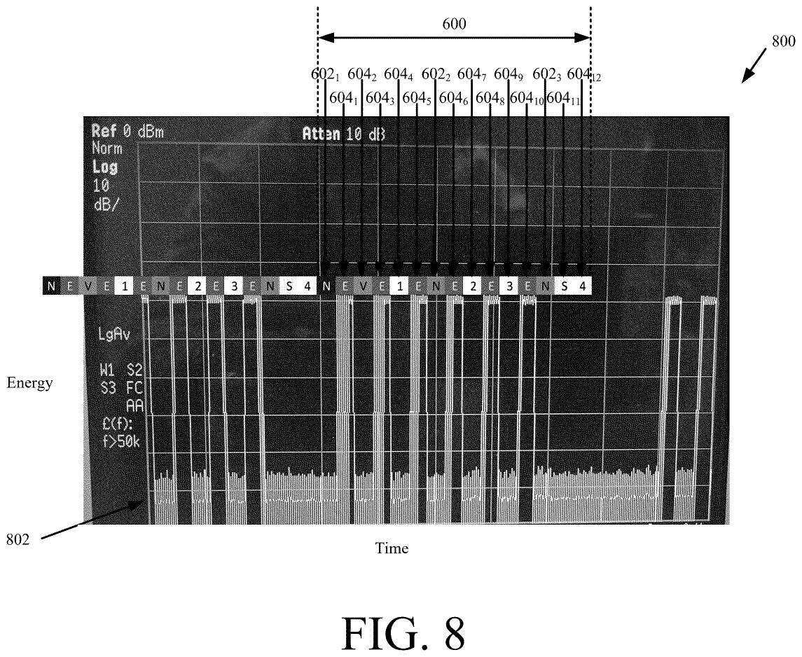

The present solution is not limited to the particulars of FIGS. 7-8. For example, a single timeslot is assigned a scan slot type in an epoch duration 600. This may not be the case in other applications. Any number of timeslots may be assigned a scan slot type in a given epoch duration in accordance with a given application. Also, the total number of scan slots may change during each of a plurality of epoch durations, i.e., each epoch duration of the plurality of epoch durations may have the same or different number of scan slots as the other epoch durations. The number of effect scan slots may also be different per epoch than that shown in FIGS. 7-8. Any number of timeslots may be assigned an effect slot type in a given epoch duration in accordance with a given application. Also, the total number of effect slots may change during each of a plurality of epoch durations, i.e., each epoch duration of the plurality of epoch durations may have the same or different number of effect slots as the other epoch durations. In some scenarios, a communication device may need to be turned on/off to cause the communication device to start transmitting increased RF energy during the epoch slots. This may not be needed in other scenarios.

FIG. 8 provides a graph 800 showing an illustrative waveform 702 in accordance with the slot type assignments of Table 700. The waveform 702 has an increased amount of RF energy during timeslots 604₁, 604₃, 604₅, 604₆, 604₈, 604₁₀ which were assigned the effect slot type. This increased RF energy acts to jam signals emitted from uncooperative communication devices (e.g., uncooperative communication device(s) 110 of FIG. 1). Scanning operations are performed in timeslots 604₁₁ which was assigned a scan slot type. The scanning operations involve receiving RF signals, analyzing the received RF signals to detect characteristics thereof and/or determination parameters of the uncooperative communication devices. For example, the modulation technique employed by an uncooperative communication device may be determined based on detected characteristics of received signal(s).

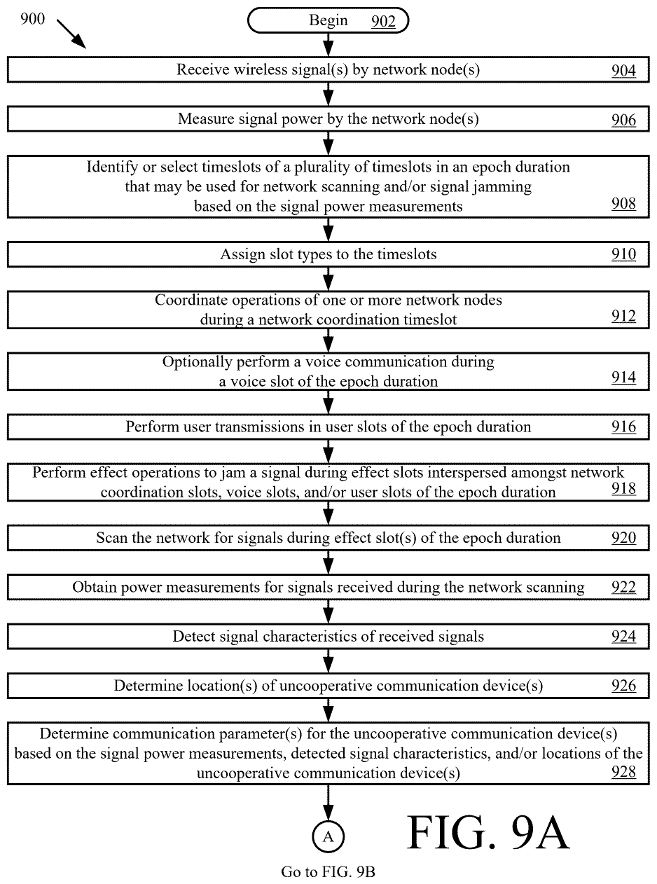

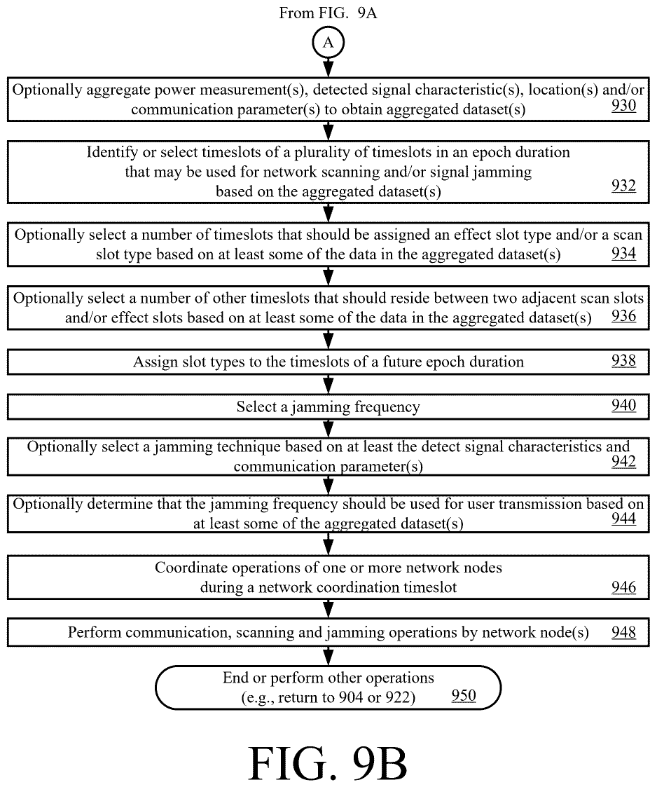

FIG. 9 provides a flow diagram of an illustrative method 900 for operating a communication network (e.g., ad hoc network 150 of FIG. 1). Method 900 begins with 902 and continues with 904 where wireless signal(s) is/are received by network node(s) (e.g., radios 102₁, . . . , 102_{N}, control device 136, and/or aerial vehicle(s) 120 of FIG. 1). The network node(s) perform(s) operations in block 906 to measure the power of the received signal(s). Any known or to be known techniques for measuring signal power can be used here. Next in block 908, one or more of the network node(s) identify or select timeslots of a plurality of timeslots (e.g., timeslots 504₁-504ₙ, or 604₁-604₁₂ of FIG. 6) in an epoch duration (e.g., epoch duration 500 of FIG. 5 or 600 of FIG. 6) that may be used for network scanning and/or signal jamming based on at least the signal power measurements. In some scenarios, a given node (e.g., control device 136 of FIG. 1) is configured to act as a centralized network controller, and thus perform the operations of block 908. Alternatively, the system may employ a distributed control architecture in which two or more network nodes are configured to separately or collectively perform the operations of block 908.

Slot types are assigned by the network node(s) in block 910 to the timeslots of the epoch duration. The slot types can include, but are not limited to, an effect slot, a voice slot, a user (radio transmit) slot, and/or a scan slot. For example, one or more timeslots (e.g., timeslots 604₁, 604₃, 604₅, 604₆, 604₈, and/or 604₁₀ of FIGS. 6-7) are assigned an effect slot type. One or more other timeslots (e.g., timeslot 604₂ of FIGS. 6-7) are assigned a voice slot type. Other timeslot(s) (e.g., timeslots 604₄, 604₇, 604₉, and/or 604₁₂ of FIGS. 6-7) is(are) assigned a user slot (or radio transmit) type. The remaining timeslot(s) (e.g., timeslot 604₁₁ of FIGS. 6-7) is(are) assigned a scan slot type. The slot type assignments case respective operations to be scheduled for performance by network nodes during the timeslots. Accordingly, operations of one or more nodes may be configured or otherwise controlled in block 912. Thus, block 912 may involve coordinating operations of a node and/or amongst the network nodes during a network coordination timeslot (e.g., network coordination timeslot 502 of FIG. 5, or 602₁, 602₂ or 602₃ of FIG. 6). Any known or to be known technique for coordinating operations among network nodes can be used here. In blocks 914-920, the network nodes perform operations in accordance with the assigned slot types. Specifically, the network nodes perform: an optional voice communication during a voice slot of the epoch duration; user transmissions in user (or radio transmit) slots; effect operations in effect slot(s); and scan operations in scan slot(s). The effect slots may be interspersed amongst network coordination slots, voice slots, and/or user (or radio transmit) slots of the epoch duration. The effect operations are configured to jam a signal during effect slots. The scan operations are configured to scan a network for signals and receive signals.

The network node(s) also perform operations to: take measurements of received signal power in block 922; analyze the received signals to detect signal characteristics thereof in block 924; determine location(s) of uncooperative communication device(s) (e.g., uncooperative communication device(s) 110 of FIG. 1) in block 926; and determine communication parameter(s) for the uncooperative communication device(s) in block 928. The signal characteristics can include, but are not limited to, amplitude, frequency, phase, pulse times, pulse width, signal signature, data link type, and/or duty cycle. Any known or to be known technique for detecting signal characteristics can be used here. The location(s) of block 926 may be determined in accordance with any known or to be known technique such as that described in the '464 Patent mentioned above. The location(s) may be determined based on, for example, the signal power measurements and/or detected signal characteristics. The communication parameters can include, but are not limited to, modulation type and/or communication mode. The communication parameter(s) may be determined based on, for example, the signal power measurements, detected signal characteristics, and/or location(s) of the uncooperative communication device(s). For example, a phase shift keying (PSK) modulation type may be determined when the phase of a received signal changes over time, or pulse width modulation (PWM) type may be determined when the duty cycle of the received signal changes or otherwise varies over time. An amplitude modulation (AM) communication mode may be determined when the amplitude of the received signal changes or otherwise varies over time. A frequency modulation (FM) communication mode may be determined when the frequency of the received signal changes or otherwise varies over time. The present solution is not limited to the particulars of this example.

Upon completing the operations of block 928, method 900 continues to block 930 of FIG. 9B. Block 930 involves optionally aggregating power measurement(s), detected signal characteristic(s), location(s) and/or communication parameter(s) to obtain aggregated dataset(s). The aggregated dataset(s) may be shared amongst the network nodes in block 930.

In block 932, the network node(s) identify or select timeslots of a plurality of timeslots (e.g., timeslots 504₁-504ₙ, or 604₁-604₁₂ of FIG. 6) in an epoch duration (e.g., epoch duration 500 of FIG. 5 or 600 of FIG. 6) that may be used for network scanning and/or signal jamming based on the aggregated dataset(s). Some or all of the aggregated dataset(s) may also optionally be used in blocks 934-936 to (i) select a number of timeslots that should be assigned an effect slot type and/or a scan slot type, and/or (ii) select a number of other timeslots that should reside between two adjacent scan slots and/or effect slots. For example, as shown in FIG. 7, six timeslots may be selected that should be assigned an effect slot type and one timeslot may be selected that should be assigned a scan slot type when the aggregate dataset(s) indicate that only four user (or radio transmit) slots are needed by the network during an epoch duration and the signal that is to be jammed is considered as likely being associated with a significant adversary based on the signal characteristics, communication parameter(s) and/or uncooperative communication device location(s) associated therewith. The present solution is not limited to the particulars of this example. Machine learning models and/or algorithms may be trained to determine whether or not a received signal is likely associated with an adversary based on patterns in signal characteristics, communication parameter(s) and/or uncooperative communication device location(s), as well as determine a significance of the adversary with a certain degree of confidence. Any known or to be known machine learning model can be used here.

In block 938, slot types are assigned to the timeslots of a further epoch duration. The manner in which the slot types are assigned may be the same as that performed in block 910 of FIG. 9A. The network node(s) select a frequency for an effect or jamming signal based on at least the detected signal characteristics.

In optional blocks 942-944, the network node(s) may perform operations to: select a jamming technique from a plurality of pre-defined jamming techniques based at least on the detected signal characteristics and/or communication parameter(s); and/or determine that the jamming frequency should be used for user transmission based on at least some of the aggregated dataset(s). Other techniques that can be used here include, but are not limited to, protocol spot jamming, narrowband swept tone, fast Fourier transform (FFT) barrage jamming, and others. In the protocol spot jamming scenarios, the jammer may provide focused power on sections of the waveform to disrupt known timing and frequency characteristics of adversary's protocol, after signal characteristics of an uncooperative network are determined. In the narrowband swept tone scenarios, the system applies a narrowband tone swept across multiple frequencies to attack an uncooperative network radios automatic gain control (AGC). In the FFT barrage jamming scenario, during the scan slots, a fast Fourier transform is run collecting spectrum data across a bandwidth dived into a series of bins. Any bin above a pre-defined threshold is provided a modulated tone across the bandwidth of the bin. Jamming techniques that could be employed here include the use of one or more narrowband tones, wideband noise, swept tones, digital radio frequency memory (DRFM) attack (e.g., a replay attack). Techniques may be selected based on a pre-defined table of effective reactions to the detected uncooperative signal or user selection. Activating the jamming transmissions may be optional based on user choice (e.g., enable and/or disable) or by pre-defined thresholds on detected uncooperative signal characteristics (e.g., detected, power level, location, time, etc.), or by command from another node in the network. Jamming frequencies may be determined based on detected characteristics of the uncooperative signal. The detected frequency could be used, as well as a pre-defined table of known frequencies by the detected signal type. For example, 802.11 operates on known channels.

Operations of one or more nodes may be configured or otherwise controlled in block 946. Accordingly, block 946 may involve coordinating operations for a node and/or amongst the network nodes. This coordination may be made in the same manner as that of block 912. Next in block 948, the network nodes perform communication, scanning and jamming operations in accordance with the slot type assignments. Subsequently, method 900 continues to block 950 where it ends or other operations are performed (e.g., return to block 904 or 922 of FIG. 9A).

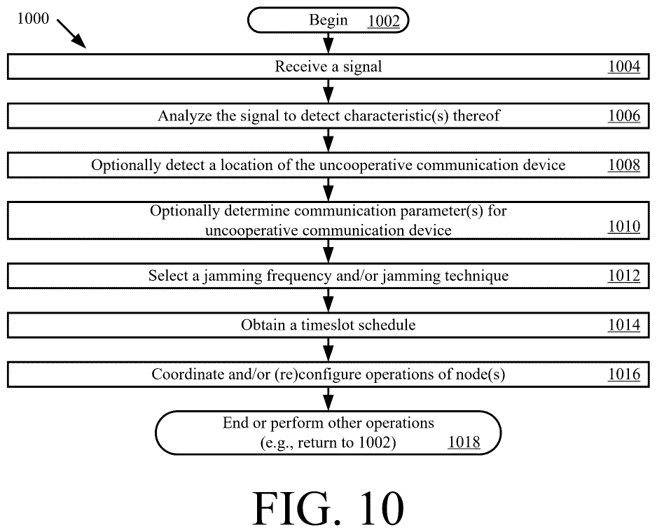

FIG. 10 provides a flow diagram of a method 1000 for operating a communication network (e.g., ad hoc network 150 of FIG. 1) employing a timing-based waveform (e.g., a TDMA waveform). Method 1000 begins with 1002 and continues with 1004 where a signal is received, for example, by a first node (e.g., radio 102₁ of FIG. 1) of a plurality of nodes (e.g., 102₁, . . . , 102_{N}, 136 and/or 120 of FIG. 1) in the communication network. Next in block 1006, the first node analyzes the signal to detect one or more characteristics thereof. The characteristics can include, but are not limited to, measured signal power, an amplitude, a frequency, a phase, a pulse time, a pulse width, a signal signature, a data link type, and/or a duty cycle.

A location of an uncooperative communication device (e.g., uncooperative communication device 110 of FIG. 1) may optionally be detected by the first node in block 1008. The first node may optionally determine communication parameter(s) for the uncooperative communication device, as shown by block 1010. The communication parameter(s) can include, but are not limited to, a modulation type and/or a communication mode.

In block 1012, a jamming frequency and/or jamming technique is selected by the first node or another second node of the network. The jamming technique may be selected from a plurality of pre-defined jamming techniques based on the detected signal characteristics, the determined communication parameter(s) for the uncooperative communication device, and/or the detected location of the uncooperative communication device.

In block 1014, a timeslot schedule is obtained based on the detected one or more characteristics of the received signal, the determined communication parameter(s) for the uncooperative communication device, and/or the detected location of the uncooperative communication device. The timing schedule may be obtained by the first node or the another second node of the network. The timeslot schedule comprises at least one first timeslot of a plurality of timeslots in an epoch duration that is to be used for network scanning and at least one second timeslot of the plurality of timeslots that is to be used for signal jamming.

In some scenarios, the timeslot schedule may be selected from a plurality of pre-defined timeslots schedules based on the detected one or more characteristics of the received signal. Alternatively, the timeslot schedule may be obtained by: selecting, based on the detected one or more characteristics of the received signal, the at least one first timeslot and the at least one second timeslot from the plurality of timeslots in the epoch duration; and assigning one of a plurality of slot types to each one of the plurality of timeslots based on the selecting. The slot types can include, but are not limited to, an effect slot type, a user slot type, and a scan slot type. The first timeslots may be interspersed amongst third timeslots of the user slot type.

In block 1016, operations are coordinated for a node and/or amongst the nodes of the communication network so that they emit a noise or jamming signal during the first timeslot(s), scan for signals transmitted by an uncooperative communication device during the second timeslot(s), and transmit communication signals during respective third timeslot(s) of the plurality of timeslots. Block 1016 may also involve (re)configuring the node(s) to transmit the communication signals during respective third timeslot(s) using the selected jamming frequency. Subsequently, method 1000 continues to block 1018 where it ends or other operations are performed (e.g., return to 1002).

The present solution has been described above in relation to time-based waveform applications, such as time division multiple access applications. The present solution is not limited in this regard. The present solution may also be employed in other applications such as frequency division multiple access (FDMA) applications.

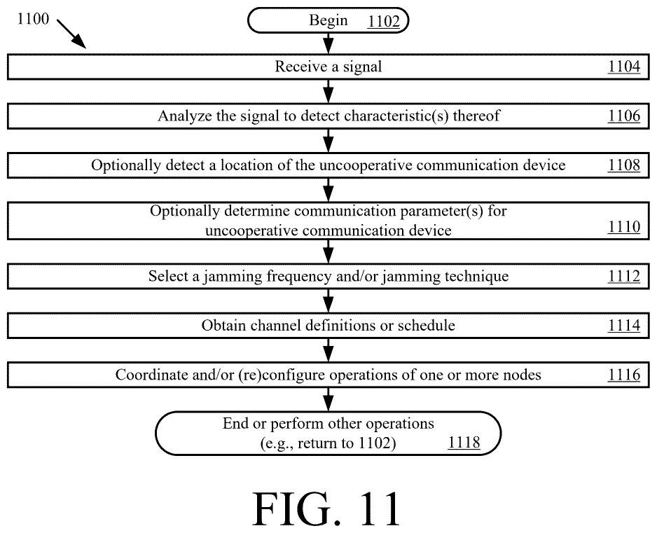

FIG. 11 provides a flow diagram of an illustrative method 1100 for operating a communication network (e.g., ad hoc network 150 of FIG. 1) in which channels are created. For example, in FDMA scenarios, the channels are created by assigning users to respective frequency bands of a plurality of non-overlapping frequency bands.

Method 1100 begins with 1102 and continues with 1104 where a signal is received, for example, by a first node (e.g., radio 102₁ of FIG. 1) of a plurality of nodes (e.g., 102₁, . . . , 102_{N}, 136 and/or 120 of FIG. 1) in the communication network. Next in block 1106, the first node analyzes the signal to detect one or more characteristics thereof. The characteristics can include, but are not limited to, measured signal power, an amplitude, a frequency, a phase, a pulse time, a pulse width, a signal signature, a data link type, and/or a duty cycle.

A location of an uncooperative communication device (e.g., uncooperative communication device 110 of FIG. 1) may optionally be detected by the first node in block 1108. The first node may optionally determine communication parameter(s) for the uncooperative communication device, as shown by block 1110. The communication parameter(s) can include, but are not limited to, a modulation type and/or a communication mode.

In block 1112, a jamming frequency and/or jamming technique is selected by the first node or another second node of the network. The jamming technique may be selected from a plurality of pre-defined jamming techniques based on the detected signal characteristics, the determined communication parameter(s) for the uncooperative communication device, and/or the detected location of the uncooperative communication device.

In block 1114, a channel schedule or channel definition(s) is(are) obtained based on the detected one or more characteristics of the received signal, the determined communication parameter(s) for the uncooperative communication device, and/or the detected location of the uncooperative communication device. The channel schedule/definition(s) may be obtained by the first node or the another second node of the network. The channel schedule/definition comprises at least one first channel of a plurality of channels in a frequency band that is to be used for network scanning and at least one second channel of the plurality of channels that is to be used for signal jamming. The first channel may be defined by (i) first frequency(ies) of the plurality of non-overlapping frequencies, or (ii) a first frequency band of the plurality of non-overlapping frequency bands that was assigned to user(s) for network scanning. The second channel may be defined by (i) different second frequency(ies) of the plurality of non-overlapping frequencies, or (ii) a different second frequency band of the plurality of non-overlapping frequency bands that was assigned to user(s) for signal jamming.

In some scenarios, the channel schedule/definition(s) may be selected from a plurality of pre-defined channel schedules/definitions based on the detected one or more characteristics of the received signal. Alternatively, the channel schedules/definition(s) may be obtained by: selecting, based on the detected one or more characteristics of the received signal, the at least one first channel and the at least one second channel from the plurality of channels in the frequency band; and assigning one of a plurality of channel types to each one of the plurality of channels based on the selecting. The channel types can include, but are not limited to, an effect channel type, a user channel type, and a scan channel type. The first channels may be interspersed amongst third channels of the user channel type.

In block 1116, operations are coordinated for a node and/or amongst the nodes of the communication network so that they emit a noise or jamming signal during the first channel(s) using the selected jamming frequency and/or jamming technique, scan for signals transmitted by an uncooperative communication device during the second channel(s), and transmit communication signals during respective third channel(s) of the plurality of channels. Subsequently, method 1100 continues to block 1118 where it ends or other operations are performed (e.g., return to 1102).

In view of the forgoing discussion, the present solution concerns implementing systems and methods for operating a communication network. The communication network may employ a timing-based waveform. The implementing systems can include, but are not limited to, a communication device. The communication may comprise a transceiver (e.g., components 306, 308 of FIG. 3 or radio 422 of FIG. 4) and a processor (e.g., controller 310 of FIG. 3 or computing device 402 of FIG. 4B). The transceiver is configured to receive a signal (e.g., a signal transmitted from an uncooperative communication device 110 of FIG. 1). The processor is configured to: analyze the signal to detect one or more characteristics thereof; obtain, based on the detected one or more characteristics of the received signal, a timeslot schedule comprising at least one first timeslot of a plurality of timeslots in an epoch duration that is to be used for network scanning and at least one second timeslot of the plurality of timeslots that is to be used for signal jamming; and emit a noise or jamming signal during the at least one first timeslot, scan for signals transmitted by an uncooperative communication device during the at least one second timeslot, and transmit a communication signal during a respective third timeslot of the plurality of timeslots. The detected characteristics can include, but are not limited to, measured signal power, an amplitude, a frequency, a phase, a pulse time, a pulse width, a signal signature, a data link type, and/or a duty cycle.

The timeslot schedule may be obtained by: selecting, based on the detected one or more characteristics of the received signal, the at least one first timeslot and the at least one second timeslot from the plurality of timeslots in the epoch duration; and assigning one of a plurality of slot types to each one of the plurality of timeslots based on the selecting. The plurality of slot types comprises at least an effect slot type, a user slot type, and a scan slot type. Alternatively, the timeslot schedule is obtained by selecting a timeslot schedule of a plurality of pre-defined timeslots schedules based on the detected one or more characteristics of the received signal.

The processor may be configured to: detect a location of the uncooperative communication device based on the detected one or more characteristics of the received signal; and/or determine at least one communication parameter for the uncooperative communication device based on at least the detected one or more characteristics of the received signal. The timeslot schedule may be obtained further based on the location of the uncooperative communication device, and/or the determined communication parameter(s). The communication parameter(s) can include, but are not limited to, a modulation type or a communication mode.

The processor may be configured to: select a jamming frequency to be used during the first timeslot(s) based on the detected characteristic(s) of the received signal; and/or (re)configure the communication device to transmit the communication signal during the respective third timeslot using the selected jamming frequency. The communication device may comprise a ground-based radio or may be disposed on an aerial vehicle.

The present solution also concerns implementing systems and methods for controlling a communications network. The communications network may employ time-based waveforms or other types of waveforms (e.g., such as FDMA waveforms). The methods involve: receiving a signal by a first node of a plurality of nodes in the communication network; analyzing, by the first node, the signal to detect one or more characteristics thereof; obtaining, based on the detected one or more characteristics of the received signal, a channel schedule or definitions comprising at least one first channel of a plurality of channels in a frequency band that is to be used for network scanning and at least one second channel of the plurality of channels that is to be used for signal jamming; and coordinating operations of a node and/or among a plurality of nodes to emit a noise or jamming signal in the at least one first channel, scan for signals transmitted by an uncooperative communication device in the at least one second channel, and transmit communication signals in respective third channel(s) of the plurality of channels.

The channel schedule or definitions may be obtained by, for example: selecting, based on the detected one or more characteristics of the received signal, the at least one first channel and the at least one second channel from the plurality of channels in the frequency band; and assigning one of a plurality of channel types to each one of the plurality of channels based on the selecting, wherein the plurality of channel types comprises at least an effect channel type, a user channel type, and a scan channel type. Additionally or alternatively, the channel schedule or definitions may be obtained by, for example, selecting a channel schedule or definitions of a plurality of pre-defined channel schedules or definitions based on the detected one or more characteristics of the received signal. The first channels that are to be used for signal jamming or network scanning may be interspersed amongst third channels.

The method may also involve detecting a location of the uncooperative communication device based on the detected one or more characteristics of the received signal. The channel schedule or definitions may be obtained further based on the location of the uncooperative communication device.

The method may also involve determining at least one communication parameter for the uncooperative communication device based on at least the detected one or more characteristics of the received signal. The channel schedule or definitions may be obtained further based on the at least one communication parameter. The communication parameter can include, but is not limited to, a modulation type or a communication mode.

The present document also concerns a communication device, comprising: a transceiver configured to receive a signal; and a processor. The processor is configured to: analyze the signal to detect one or more characteristics thereof; obtain, based on the detected one or more characteristics of the received signal, channel schedule or definitions comprising at least one first channel of a plurality of channels in a frequency band that is to be used for network scanning and at least one second channel of the plurality of channels that is to be used for signal jamming; and emit a noise or jamming signal in the at least one first channel, scan for signals transmitted by an uncooperative communication device in the at least one second channel, and transmit a communication signal in a respective third channel of the plurality of channels. The characteristic(s) can include, but are not limited to, measured signal power, an amplitude, a frequency, a phase, a pulse time, a pulse width, a signal signature, a data link type, and/or a duty cycle.

The channel schedule or definitions may be obtained by: selecting, based on the detected one or more characteristics of the received signal, the at least one first channel and the at least one second channel from the plurality of channels in the frequency band; and assigning one of a plurality of channel types to each one of the plurality of channels based on the selecting, wherein the plurality of channel types comprises at least an effect channel type, a user channel type, and a scan channel type. The channel schedule or definitions may be obtained by selecting a channel schedule or definition of a plurality of pre-defined channel schedules or definitions based on the detected one or more characteristics of the received signal.

The processor may also be configured to detect a location of the uncooperative communication device based on the detected one or more characteristics of the received signal. The channel schedule or definitions may be obtained further based on the location of the uncooperative communication device.

The processor may be further configured to determine at least one communication parameter for the uncooperative communication device based on at least the detected one or more characteristics of the received signal. The channel schedule or definitions may be obtained further based on the communication parameter(s). The communication parameter can include, but is not limited to, a modulation type or a communication mode. The communication device can include, but is not limited to, a ground-based radio or is disposed on an aerial vehicle.

The described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

We claim:

1. A method for operating a communication network, comprising:
receiving a signal by a first node of a plurality of nodes in the communication network;
analyzing, by the first node, the signal to detect one or more characteristics thereof;
obtaining, based on the detected one or more characteristics of the received signal, a timeslot schedule comprising at least one first timeslot of a plurality of timeslots in an epoch duration that is to be used for network scanning and at least one second timeslot of the plurality of timeslots that is to be used for signal jamming; and
controlling operations of a node to emit a noise or jamming signal during the at least one first timeslot, scan for signals transmitted by an uncooperative communication device during the at least one second timeslot, and transmit communication signals during respective third timeslots of the plurality of timeslots.

2. The method according to claim 1, further comprising coordinating operations among a plurality of nodes to emit a noise or jamming signal during the at least one first timeslot, scan for signals transmitted by an uncooperative communication device during the at least one second timeslot, and transmit communication signals during respective at least one third timeslot of the plurality of timeslots.

3. The method according to claim 1, wherein the one or more characteristics comprises one or more of measured signal power, an amplitude, a frequency, a phase, a pulse time, a pulse width, a signal signature, a data link type, and a duty cycle.

4. The method according to claim 1, wherein said obtaining further comprises:
selecting, based on the detected one or more characteristics of the received signal, the at least one first timeslot and the at least one second timeslot from the plurality of timeslots in the epoch duration; and
assigning one of a plurality of slot types to each one of the plurality of timeslots based on the selecting, wherein the plurality of slot types comprises at least an effect slot type, a user slot type, and a scan slot type.

5. The method according to claim 1, wherein said obtaining further comprises selecting a timeslot schedule of a plurality of pre-defined timeslots schedules based on the detected one or more characteristics of the received signal.

6. The method according to claim 1, further comprising interspersing a plurality of first timeslots that are to be used for signal jamming or network scanning amongst third timeslots.

7. The method according to claim 1, further comprising:
detecting a location of the uncooperative communication device based on the detected one or more characteristics of the received signal;
wherein the obtaining is further based on the location of the uncooperative communication device.

8. The method according to claim 1, further comprising:
determining at least one communication parameter for the uncooperative communication device based on at least the detected one or more characteristics of the received signal;
wherein the obtaining is further based on the at least one communication parameter.

9. The method according to claim 8, wherein the at least one communication parameter comprises a modulation type or a communication mode.

10. The method according to claim 1, further comprising selecting a jamming frequency to be used during the at least one first timeslot based on the detected one or more characteristics of the received signal.

11. The method according to claim 10, further comprising re-configuring the plurality of network nodes to transmit the communication signals during respective third timeslots using the selected jamming frequency.

12. A communication device, comprising:
a transceiver configured to receive a signal; and
a processor configured to:
analyze the signal to detect one or more characteristics thereof;
obtain, based on the detected one or more characteristics of the received signal, a timeslot schedule comprising at least one first timeslot of a plurality of timeslots in an epoch duration that is to be used for network scanning and at least one second timeslot of the plurality of timeslots that is to be used for signal jamming; and
emit a noise or jamming signal during the at least one first timeslot, scan for signals transmitted by an uncooperative communication device during the at least one second timeslot, and transmit a communication signal during a respective third timeslot of the plurality of timeslots.

13. The communication device according to claim 12, wherein the one or more characteristics comprises one or more of measured signal power, an amplitude, a frequency, a phase, a pulse time, a pulse width, a signal signature, a data link type, and a duty cycle.

14. The communication device according to claim 12, wherein the timeslot schedule is obtained by:
selecting, based on the detected one or more characteristics of the received signal, the at least one first timeslot and the at least one second timeslot from the plurality of timeslots in the epoch duration; and
assigning one of a plurality of slot types to each one of the plurality of timeslots based on the selecting, wherein the plurality of slot types comprises at least an effect slot type, a user slot type, and a scan slot type.

15. The communication device according to claim 12, wherein the timeslot schedule is obtained by selecting a timeslot schedule of a plurality of pre-defined timeslots schedules based on the detected one or more characteristics of the received signal.

16. The communication device according to claim 12, wherein the processor is further configured to:
detect a location of the uncooperative communication device based on the detected one or more characteristics of the received signal;
wherein the timeslot schedule is obtained further based on the location of the uncooperative communication device.

17. The communication device according to claim 12, wherein the processor is further configured to:
determine at least one communication parameter for the uncooperative communication device based on at least the detected one or more characteristics of the received signal;
wherein the timeslot schedule is obtained further based on the at least one communication parameter.

18. The communication device according to claim 17, wherein the at least one communication parameter comprises a modulation type or a communication mode.

19. The communication device according to claim 12, wherein the processor is further configured to select a jamming frequency to be used during the at least one first timeslot based on the detected one or more characteristics of the received signal.

20. The communication device according to claim 19, wherein the processor is further configured to re-configure the communication device to transmit the communication signal during the respective third timeslot using the selected jamming frequency.

21. The communication device according to claim 12, wherein the communication device comprises a ground-based radio or is disposed on an aerial vehicle.

22. A method for operating a communication network, comprising:
receiving a signal by a first node of a plurality of nodes in the communication network;
analyzing, by the first node, the signal to detect one or more characteristics thereof;
obtaining, based on the detected one or more characteristics of the received signal, a channel schedule comprising at least one first channel of a plurality of channels in a frequency band that is to be used for network scanning and at least one second channel of the plurality of channels that is to be used for signal jamming; and
controlling a node to emit a noise or jamming signal during the at least one first channel, scan for signals transmitted by an uncooperative communication device during the at least one second channel, and transmit communication signals during respective at least one third channel of the plurality of channels.

23. The method according to claim 22, wherein each of the plurality of channels is defined by a respective frequency band of a plurality of non-overlapping frequency bands.

24. The method according to claim 22, further comprising coordinating operations among a plurality of nodes to emit a noise or jamming signal during the at least one first channel, scan for signals transmitted by an uncooperative communication device during the at least one second channel, and transmit communication signals during respective third channels of the plurality of channels.

25. The method according to claim 22, wherein said obtaining further comprises:
selecting, based on the detected one or more characteristics of the received signal, the at least one first channel and the at least one second channel from the plurality of channels in the frequency band; and
assigning one of a plurality of channel types to each one of the plurality of channels based on the selecting, wherein the plurality of channel types comprises at least an effect channel type, a user channel type, and a scan channel type.

26. The method according to claim 22, wherein said obtaining further comprises selecting a channel schedule or definitions of a plurality of pre-defined channel schedules or definitions based on the detected one or more characteristics of the received signal.

27. The method according to claim 22, further comprising interspersing a plurality of first channels that are to be used for signal jamming or network scanning amongst third channels.

28. The method according to claim 22, further comprising:
detecting a location of the uncooperative communication device based on the detected one or more characteristics of the received signal;
wherein the obtaining is further based on the location of the uncooperative communication device.

29. The method according to claim 22, further comprising:
determining at least one communication parameter for the uncooperative communication device based on at least the detected one or more characteristics of the received signal;
wherein the obtaining is further based on the at least one communication parameter.

30. The method according to claim 29, wherein the at least one communication parameter comprises a modulation type or a communication mode.
